(19) United States
(12) Patent Application Publication
(10) Pub. No.: US 2006/0249182 A1
(43) Pub. Date: Nov. 9, 2006

(54) Cleaning method and cleaning apparatus

(76) Inventors: Naoya Hayamizu, Yokohama-shi (JP); Hiroshi Fujita, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/392,615

(22) Filed: Mar. 30, 2006

(30) Foreign Application Priority Data
Mar. 31, 2005 (JP) 2005-100330
Mar. 31, 2005 (JP) 2005-105071
Mar. 31, 2005 (JP) 2005-105072

(51) Int. Cl. B08B 3/12; B08B 3/00; B08B 7/00

(52) U.S. Cl. 134/34; 134/33; 134/198; 134/94.1; 134/1; 134/26

(57) ABSTRACT

A cleaning apparatus of this invention includes a cleaning water supply portion which supplies alkaline cleaning water, a high-pressure supply portion which supplies high-pressure air, and a two-fluid nozzle which atomizes the supplied cleaning water by mixing with the high-pressure air and sprays to a work piece.

### CROSS-REFERENCE TO RELATED APPLICATIONS

This application is based upon and claims the benefit of priority from prior Japanese Patent Applications No. 2005-100330, filed Mar. 31, 2005; No. 2005-105071, filed Mar. 31, 2005; and No. 2005-105072, filed Mar. 31, 2005, the entire contents of all of which are incorporated herein by reference.

### BACKGROUND OF THE INVENTION

1. Field of the Invention

The present invention relates to a cleaning method and cleaning apparatus for cleaning a work piece such as a semiconductor wafer and display, more particularly to an electronic device cleaning method and electronic device cleaning apparatus capable of removing particles without damaging a device pattern.

2. Description of the Related Art

A semiconductor device manufacturing process includes a step of forming fine patterns by repeating formation of film or etching on the surface of a semiconductor wafer. Since both surfaces of the semiconductor wafer, particularly its thin film formation surface needs to be kept clean to form the fine pattern, a process of cleaning the semiconductor wafer is carried out using a substrate cleaning apparatus. The substrate cleaning apparatus which cleans the semiconductor wafer removes adhering particles by atomizing pure water with high-pressure air or high-pressure nitrogen and strike it against the substrate using a two-fluid nozzle (see, for example, Jpn. Pat. Applin. KOKAI Publication No. 2002-270564).

Like the semiconductor wafer, electronic devices such as a liquid crystal display and PDP substrate are cleaned using the same kind of the cleaning apparatus.

The above-described method of cleaning the semiconductor wafer has a following problem. That is, according to the method of atomizing pure water with high-pressure air or high-pressure nitrogen so as to remove particles, particles leaving the surface of the semiconductor wafer adhere to the surface of the wafer again in a process of being carried for discharge within liquid film on the semiconductor wafer, so that the particles cannot be removed sufficiently.

Raising the pressure of pure water pressure, high-pressure air or high-pressure nitrogen to improve particle removing rate has such a problem that it is not suitable for actual use because the raised pressure damages a device pattern formed on the surface of the semiconductor wafer.

Although the material of the two-fluid nozzle is SUS in a process which does not need to consider metal impurity, resin such as Teflon, PEEK is used in a process which needs to control the metal impurity. As a result, electric charge is applied when liquid is atomized and carried in the air. This electric charge moves to the top of the substrate or component of the apparatus such as a spin cup and the charged substrate attracts particles in the air so that it may be polluted by the particles.

Further, since water is collected on the substrate after cleaning, water is dried by spinning or blowing with nitrogen or the like. At this time, there is a fear that in case of a fine pattern, adjoining patterns may attract each other by the surface tension of water so that they may be damaged.

### BRIEF SUMMARY OF THE INVENTION

An object of the present invention is to remove fine particles sufficiently without damaging the surface of a work piece.

A cleaning method and a cleaning apparatus of the present invention are configured as follows.

A cleaning method comprising: supplying alkaline cleaning water; supplying high-pressure air; and atomizing the supplied cleaning water by mixing with the air and spraying to a work piece.

A cleaning apparatus comprising: cleaning water supply means for supplying alkaline cleaning water; high-pressure air supply means for supplying high-pressure air; and a two-fluid nozzle which atomizes the supplied cleaning water by mixing with the air and sprays to a work piece.

A cleaning apparatus comprising: cleaning water supply means for supplying cleaning water; high-pressure air supply means for supplying high-pressure air; and a two-fluid nozzle which atomizes the supplied cleaning water by mixing with the air and sprays to a work piece, wherein the two-fluid nozzle is formed of conductive material obtained by mixing nonconductive resin with carbon filler.

A cleaning apparatus comprising: cleaning water supply means for supplying cleaning water; high-pressure air supply means for supplying high-pressure air; and a two-fluid nozzle which atomizes the supplied cleaning water by mixing with the air and sprays to a work piece, wherein the two-fluid nozzle is formed of any of titanium, tantalum, zirconium and an alloy thereof.

A cleaning apparatus comprising: cleaning water supply means for supplying cleaning water; high-pressure air supply means for supplying high-pressure air; and a two-fluid nozzle which atomizes the supplied cleaning water by mixing with the air and sprays to a work piece, wherein the two-fluid nozzle is formed of silicone, silicone carbide or a mixture thereof doped with impurity.

A cleaning apparatus comprising: cleaning water supply means for supplying cleaning water; high-pressure air supply means for supplying high-pressure air; and a nonconductive two-fluid nozzle which atomizes the supplied cleaning water by mixing with the air and sprays to a work piece, wherein the two-fluid nozzle is provided with a grounding portion which grounds the cleaning water or the air passing through the two-fluid nozzle.

A cleaning apparatus comprising: cleaning water supply means for supplying cleaning water; high-pressure air supply means for supplying high-pressure air; a two-fluid nozzle which atomizes the supplied cleaning water by mixing with the air and sprays to a work piece; and an ionizer which neutralizes the electronic device.

A cleaning method comprising: supplying cleaning water; supplying high-pressure air; atomizing the supplied cleaning water by mixing with the air and spraying to a work piece; and neutralizing the electronic device with an ionizer.

A cleaning method comprising: supplying cleaning water containing organic solvent; supplying high-pressure air; and atomizing the supplied cleaning water by mixing with the air and spraying to a work piece.

A cleaning apparatus comprising: cleaning water supply means for supplying cleaning water containing organic solvent; high-pressure air supply means for supplying high-pressure air; and a two-fluid nozzle which atomizes the supplied cleaning water by mixing with the air and sprays to a work piece.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is an explanatory diagram showing the structure of a substrate cleaning apparatus according to a first embodiment of the present invention;

FIG. 2 is a explanatory diagram showing the reason why alkali aqueous solution is used in the same substrate cleaning apparatus;

FIG. 3 is a explanatory diagram showing the reason why alkali aqueous solution is used in the same substrate cleaning apparatus;

FIG. 4 is a explanatory diagram showing the reason why alkali aqueous solution is used in the same substrate cleaning apparatus;

FIG. 5 is a explanatory diagram showing the reason why alkali aqueous solution is used in the same substrate cleaning apparatus;

FIG. 6 is an explanatory diagram showing the structure of a substrate cleaning apparatus according to a second embodiment of the present invention;

FIG. 7 is a longitudinal sectional view showing a two-fluid nozzle incorporated in the same substrate cleaning apparatus;

FIG. 8 is a longitudinal sectional view showing a modification of the same two-fluid nozzle;

FIG. 9 is an explanatory diagram showing the structure of a substrate cleaning apparatus according to a third embodiment of the present invention;

FIG. 10 is a diagram showing the relation between a flow rate of nitrogen and the quantity of damages of a device pattern in the same substrate cleaning apparatus; and

FIG. 11 is a diagram showing the relation between the flow rate of nitrogen and the quantity of damages of the device pattern in the same substrate cleaning apparatus.

### DETAILED DESCRIPTION OF THE INVENTION

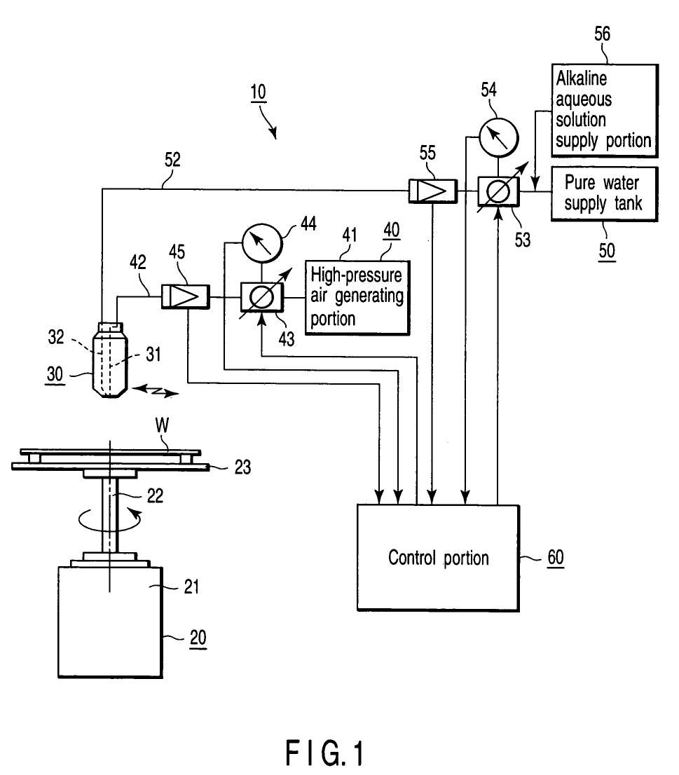

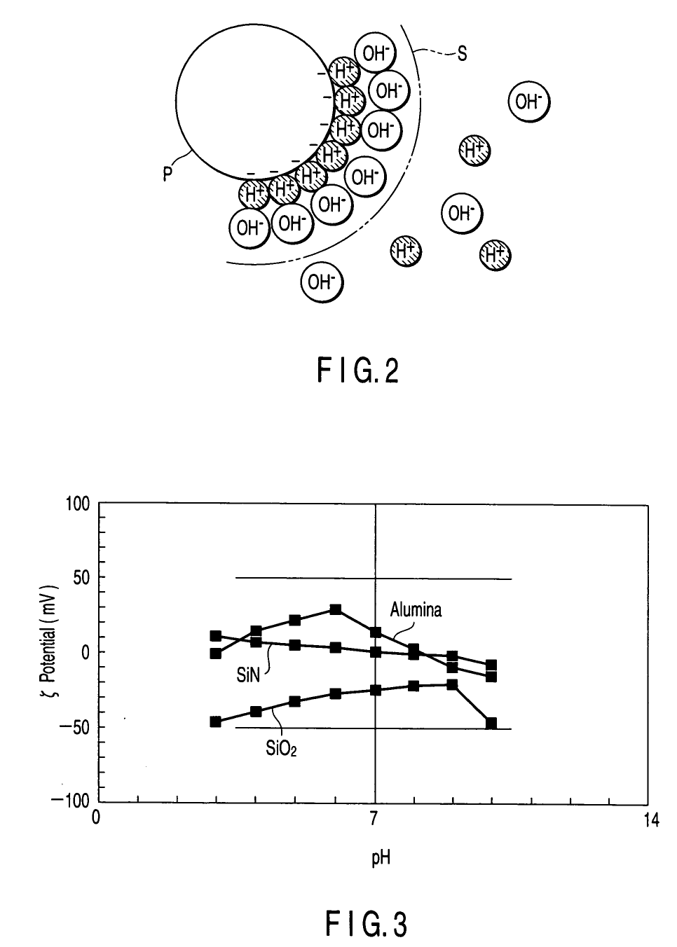

FIG. 1 is an explanatory diagram showing the structure of a substrate cleaning apparatus 10 according to a first embodiment of the present invention and FIGS. 2 to 5 are explanatory diagrams showing the reason why alkali aqueous solution is used in the substrate cleaning apparatus 10.

The substrate cleaning apparatus 10 comprises a cleaning portion 20, a high-pressure air supply portion 40, a cleaning water supply portion 50 and a control portion 60 for controlling these portions in harmony with each other.

The cleaning portion 20 comprises an electric motor 21 which is controlled by the control portion 60, a spin chuck 23 which is mounted on a rotation shaft 22 of this electric motor 21 for holding a semiconductor wafer W, and a two-fluid nozzle 30 disposed to oppose the spin chuck 23. The two-fluid nozzle 30 includes a gas passage 31 through which high-pressure air flows which is disposed in the center and a cleaning water passage 32 which is disposed around this gas passage 31 and through which cleaning water flows. The gas passage 31 is connected to an air pipe 42 described later and the cleaning water passage 32 is connected to a cleaning water pipe 52 described later so that they introduce high-pressure air and high-pressure cleaning water respectively. The two-fluid nozzle 30 is supported by a lift/moving mechanism (not shown) so that it can change a cleaning water supply position within a plane of the semiconductor wafer W.

The high-pressure air supply portion 40 comprises a high-pressure air generating portion 41, the air pipe 42 for feeding high-pressure air from the high-pressure air generating portion 41 to the two-fluid nozzle 30, a pressure adjusting portion 43 provided halfway of this air pipe 42, a pressure sensor 44 for measuring an air pressure in this pressure adjusting portion 43 and a flow rate sensor 45 provided halfway of the air pipe 42. The pressure adjusting portion 43 adjusts the pressure according to an instruction from the control portion 60. Outputs of the pressure sensor 44 and flow rate sensor 45 are inputted to the control portion 60.

The cleaning water supply portion 50 comprises a pure water supply tank 51, a cleaning water pipe 52 for feeding cleaning water from this pure water supply tank 51 to the two-fluid nozzle 30, a pressure adjusting portion 53 provided halfway of this cleaning water pipe 52, a pressure sensor 54 for measuring a cleaning water pressure in the pressure adjusting portion 53, a flow rate sensor 55 provided halfway of the cleaning water pipe 52 and an alkali aqueous solution supply portion 56 which is provided halfway of the cleaning water pipe 52 for obtaining cleaning water by adding alkali aqueous solution to the pure water. The pressure adjusting portion 53 adjusts the pressure according to an instruction from the control portion 60. Outputs of the pressure sensor 54 and the flow rate sensor 55 are inputted to the control portion 60.

As the aforementioned alkali aqueous solution, ammonia, organic alkali such as tetramethylammonium hydroxide, choline, hydroxylamine is used. Further, it is permissible to omit the alkali aqueous solution supply portion 56 by using an alkali aqueous solution supply tank which accommodates alkali aqueous solution preliminarily instead of the pure water supply tank 51.

The substrate cleaning apparatus 10 having such a structure cleans the semiconductor wafer W as follows. That is, the semiconductor wafer W is rotated by rotating the electric motor 21. The rotation speed at this time is, for example, about 500 rpm. Alkali aqueous solution is added to pure water supplied form the pure water supply tank 51 from the alkali aqueous solution supply portion 56.

Next, when the pressure adjusting portions 43, 53 are opened corresponding to a signal form the control portion 60 and air and cleaning water are supplied to the two-fluid nozzle 30, the cleaning water is atomized with high-pressure air and sprayed to the surface of the semiconductor wafer W. As a result, particles are washed out. At this time, a control signal is sent from the control portion 60 to each of the pressure adjusting portions 43, 53 so as to adjust the pressures of air and cleaning water so that cleaning water is sprayed at a predetermined pressure. At the same time, results detected from the respective pressure sensors 44, 54 and flow rate sensors 45, 55 are fed back to the control portion 60 successively.

An action of a case where alkali water is used as the cleaning water will be described here. That is, ζ potential is generated in a glide plane (S in FIG. 2) in the cleaning water. This ζ potential differs depending on the material and changes depending on pH of the cleaning water as shown in FIG. 3. The material of the semiconductor wafer W is such that SiN is formed on SiO₂, and a particle P is alumina.

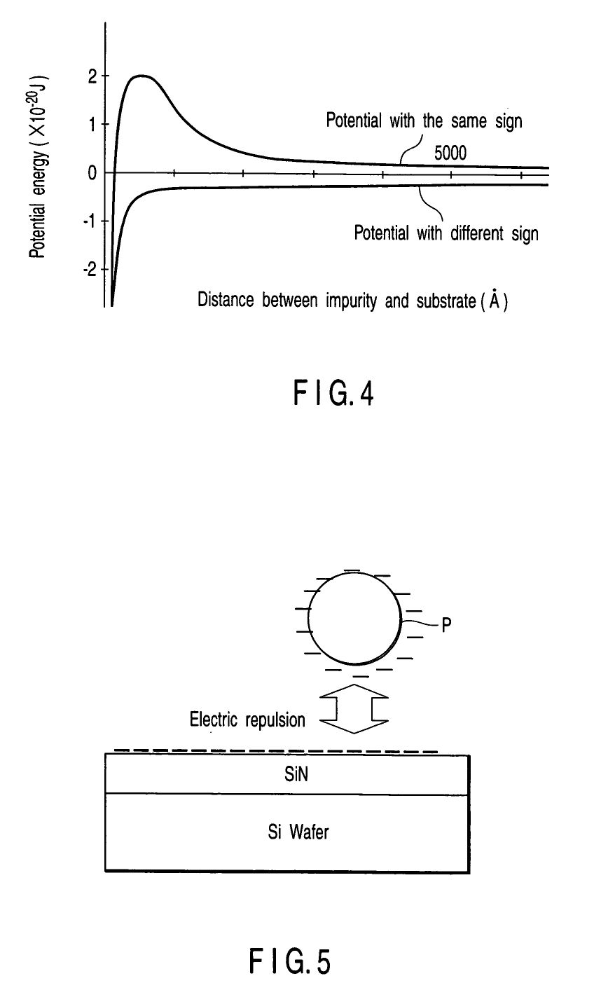

On the other hand, potential energy between two materials is a sum of intermolecular force and electrostatic potential and has a relation as shown in FIG. 4. That is, if the ζ potentials have an equal sign, a repulsive force is generated and if the ζ potentials have different signs, attractive force is generated. Therefore, if the cleaning water is alkaline (pH value is 8 or more), the ζ potential between the respective materials becomes minus so that as shown in FIG. 5, electric repulsion is generated.

As a result, both the surface potential of the semiconductor wafer W and the surface potential of the particle P turn to minus in alkaline cleaning water, thereby suppressing re-adherence of the particle P to the semiconductor wafer W. Selection of the material of the surface of the semiconductor wafer W and the alkaline cleaning water for use enables addition of the removal effect of the particle P by slight etching of the surface of the semiconductor wafer W.

As described above, the substrate cleaning method with the substrate cleaning apparatus 10 of this embodiment can prevent the particles which leave the surface of the semiconductor wafer W from re-adhering. Thus, the particles can be removed effectively. Therefore, the cleaning water does not need to be sprayed with a strong pressure, thereby preventing the device pattern from being damaged.

Examples of experiments will be described here. A semiconductor wafer W in which 55 nm line/space pattern was formed was measured by a pattern inspecting device to count the quantity of defects. This semiconductor wafer was cleaned with the substrate cleaning apparatus 10 according to the “condition 1” to “condition 3” described below.

Condition 1 is that pure water is 0.2 MPa (100 ml/min), high-pressure air is 0.2 MPa (60 L/min) and the rotation number of wafer is 500 rpm. Condition 2 is that pure water is 0.3 MPa (200 ml/min), high-pressure air is 0.3 MPa (80 L/min) and the rotation number of wafer is 500 rpm. Condition 3 is that 0.2 mmol/l ammonia water is 0.2 MPa (100 ml/min), high-pressure air is 0.2 MPa (60 L/min) and the rotation number of wafer is 500 rpm.

After the above-described treatment, the semiconductor wafer W was measured with the pattern inspecting device so as to count the quantity of defects. Increased defects were observed with review SEM so as to verify whether or not a damage existed in the pattern. As a result, the rate of removal of particles which were counted as defects was 60% under the condition 1, 80% under the condition 2 and 85% under the condition 3. Although no damage of the pattern was found out under the conditions 1, 3, the pattern damage was found at 10 positions under the condition 2. Therefore, the pressures of the cleaning water and high-pressure air are preferred to be 0.3 MPa or less. Considering the effect of cleaning, the pressures of the cleaning water and high-pressure air are preferred to be 0.1 MPa or more.

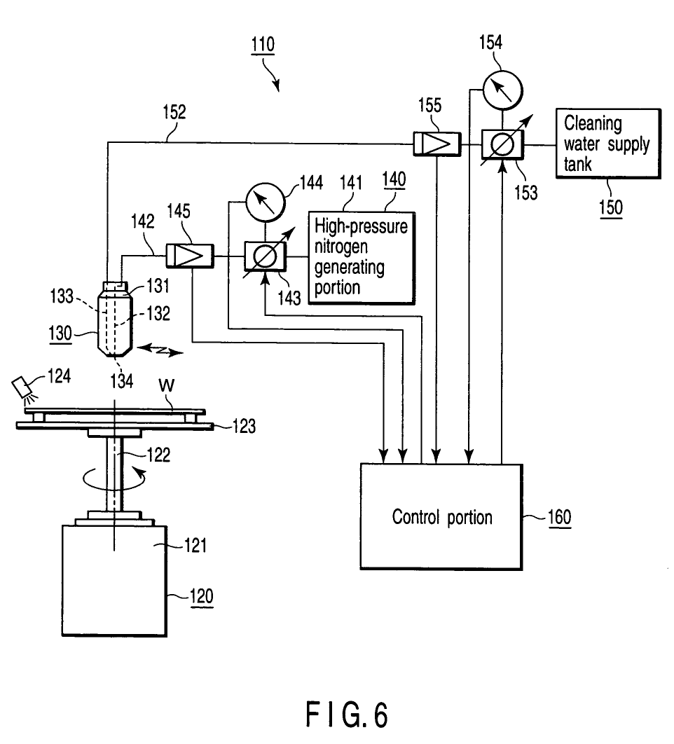

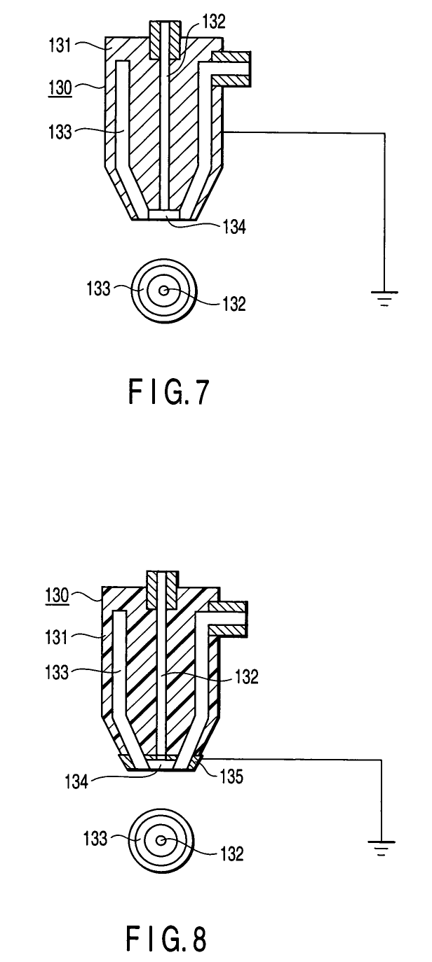

FIG. 6 is an explanatory diagram showing the structure of a substrate cleaning apparatus 110 according to a second embodiment of the present invention and FIGS. 7, 8 are diagrams showing the relation between the flow rate of nitrogen in the substrate cleaning apparatus 110 and the quantity of damages of the device pattern.

The substrate cleaning apparatus 110 comprises a cleaning portion 120, a high-pressure nitrogen supply portion 140, a cleaning water supply portion 150 and a control portion 160 for controlling these components in harmony with each other.

The cleaning portion 120 includes an electric motor 121 which is controlled by the control portion 160, a spin chuck 123 which is mounted on a rotation shaft 122 of this electric motor 121 for holding a semiconductor wafer W, and a two-fluid nozzle 130 which is disposed to oppose the spin chuck 123.

The two-fluid nozzle 130 comprises, as shown in FIG. 7, a nozzle main body 131 which is grounded, a gas passage 132 which is provided in the center of this nozzle main body 131 and through which high-pressure nitrogen passes, and a cleaning water passage 133 which is disposed around this gas passage 132 and through which cleaning water passes. Reference numeral 134 in FIG. 6 denotes a nozzle orifice. The gas passage 132 is connected to a nitrogen pipe 142 described later, and the cleaning water passage 133 is connected to a cleaning water pipe 152 so as to introduce high-pressure nitrogen and cleaning water, respectively. The two-fluid nozzle 130 is supported by a lift/moving mechanism (not shown) so as to be able to change the supply position of the cleaning water within a plane of the semiconductor wafer W.

The nozzle main body 131 for use is formed of for example, non-conductive resin (polyimide, polyether ether ketone, fluorine resin and mixture thereof) mixed with carbon filler. In the meantime, it is permissible to use titanium, tantalum, zirconium and alloy of these components. Further, it is permissible to use silicone, silicone carbide or any mixture of these components doped with impurity. These conductive materials produce no problem even when used in the cleaning process of the electronic device which needs to control metal impurity while it is unlikely to produce metal ion or produces no metal ion. In the meantime, any other conductive material may be used as long as it produces a small amount of metal ion or produces no metal ion.

The high-pressure nitrogen supply portion 140 includes a high-pressure nitrogen generating portion 141, a nitrogen pipe 142 for feeding high-pressure nitrogen from this high-pressure nitrogen generating portion 141 to the two-fluid nozzle 130, a pressure adjusting portion 143 provided halfway of this nitrogen pipe 142, a pressure sensor 144 for measuring nitrogen pressure in this pressure adjusting portion 143, and a flow rate sensor 145 provided halfway of the nitrogen pipe 142. The pressure adjusting portion 143 adjusts the pressure according to an instruction from the control portion 160. Outputs of the pressure sensor 144 and the flow rate sensor 145 are inputted to the control portion 160.

The cleaning water supply portion 150 includes a cleaning water supply tank 151, a cleaning water pipe 152 for feeding cleaning water from the cleaning water supply tank 151 to the two-fluid nozzle 130, a pressure adjusting portion 153 provided halfway of this cleaning water pipe 152, a pressure sensor 154 for measuring the pressure of the cleaning water in this pressure adjusting portion 153, and a flow rate sensor 155 provided halfway of the cleaning water pipe 152. The pressure adjusting portion 153 adjusts the pressure according to an instruction from the control portion 160. Outputs of the pressure sensor 154 and the flow rate sensor 155 are inputted to the control portion 160.

The substrate cleaning apparatus 110 having such a structure cleans the semiconductor wafer W as follows. That is, the semiconductor wafer W is rotated by rotating the electric motor 121. The rotation speed at this time is, for example, about 500 rpm.

Next, the pressure adjusting portions 143, 153 are opened based on a signal from the control portion 160. When the two-fluid nozzle 130 is supplied with nitrogen and cleaning water, the cleaning water is atomized by the high-pressure nitrogen and sprayed to the surface of the semiconductor wafer W. As a consequence, the particles are washed out. At this time, a control signal is sent from the control portions 160 to the respective pressure adjusting portions 143, 153 so as to adjust the pressures of nitrogen and cleaning water so that the cleaning water is sprayed at a predetermined pressure. At the same time, results detected by the respective pressure sensors 144, 154 and the flow rate sensors 145, 155 are fed back to the control portion 160 successively.

Since the two-fluid nozzle 130 generates little metal ion even if it is exposed to high-pressure nitrogen and cleaning water as described above, no metal impurity adheres to the semiconductor wafer W. Further, since the two-fluid nozzle is entirely conductive and grounded, it is neutralized even if it is charged. Therefore, the semiconductor wafer W and the cleaning portion 120 are never charged, thereby preventing the semiconductor wafer W from being polluted by the particles by attraction of those in the air.

As described above, the substrate cleaning apparatus 110 of this embodiment can suppress the charging when the cleaning water is atomized to a minimum extent by forming the two-fluid nozzle 130 of conductive material. Thus, the two-fluid nozzle 130, the semiconductor wafer W and the like can be prevented from being charged so as to prevent the semiconductor wafer W from being polluted by particles by attraction of the particles in the air. Therefore, the cleanliness of the substrate after cleaning can be improved.

Here, an example of experiment will be described. A semiconductor wafer W in which 55 nm line/space patterns were formed was measured with a pattern inspecting device and the quantity of defects was counted. This semiconductor wafer was cleaned with the substrate cleaning apparatus 110 under the following condition. That is, pure water is 0.2 MPa (100 ml/min), high-pressure air is 0.2 MPa (60 L/min) and the number of rotations of the semiconductor wafer is 500 rpm.

As the material of the two-fluid nozzle 130, six kinds of (1) PTFE, (2) carbon filler contained PTFE, (3) PEEK, (4) carbon filler contained PEEK, (5) titanium and (6) SiC (conductive) were used. The PTFE and PEEK are non-conductive resin and turn to conductive by mixing carbon filler.

After the above-described treatment, the semiconductor wafer W was measured with the pattern inspecting device and the quantity of defects was counted. As a consequence, the rate of removal of defects was 51% for (1), 65% for (2), 55% for (3), 69% for (4), 80% for (5) and 74% for (6). This result indicates that when the conductive material is used as the material of the two-fluid nozzle 30, the particles can be prevented from adhering again by charging thereby improving the rate of removal of the defects.

FIG. 8 is a diagram showing a modification of the two-fluid nozzle 130 according to this embodiment. If the nozzle main body 131 of the two-fluid nozzle 130 is formed of non-conductive material, it is permissible to mount an attachment (grounding portion) 135 formed of metal such as titanium around the periphery of the nozzle orifice 134 and neutralize the cleaning water by grounding this attachment 135. Further, it is permissible to neutralize the charged semiconductor wafer W and cleaning portion 120 positively by using an ionizer shown at 124 in FIG. 6 as well as neutralize the two-fluid nozzle 130 as described above to prevent occurrence of charging. Additionally, the cleanliness may be raised by combining the above-described plural methods.

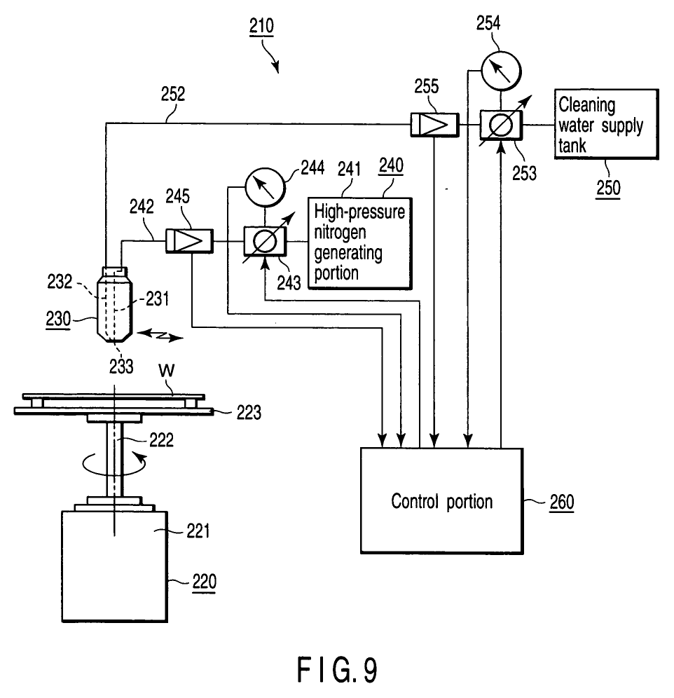

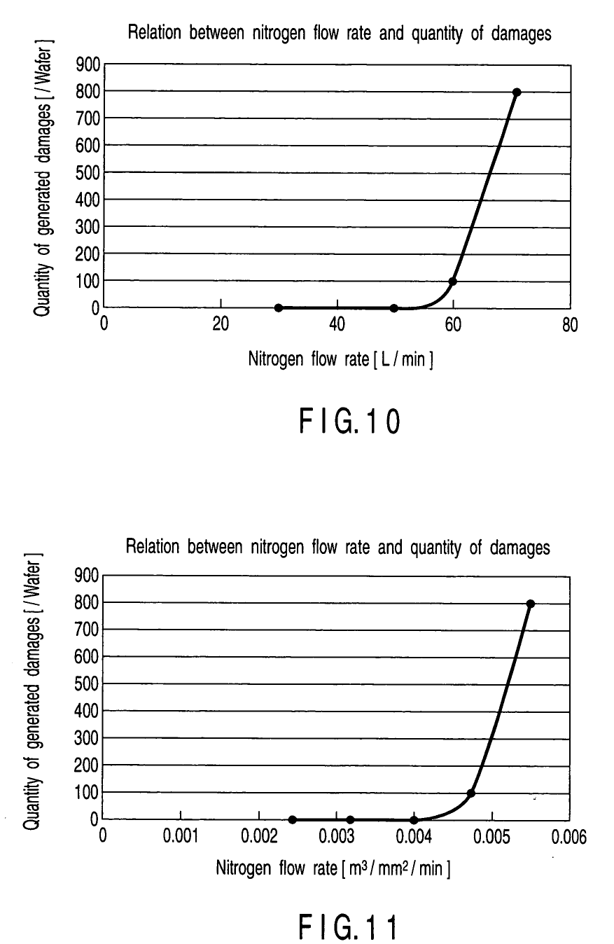

FIG. 9 is an explanatory diagram showing the structure of a substrate cleaning apparatus 210 according to a third embodiment of the present invention. FIGS. 10 and 11 are diagrams showing the relation between the flow rate of nitrogen in the substrate cleaning apparatus 210 and the quantity of damages in the device pattern.

The substrate cleaning apparatus 210 comprises a cleaning portion 220, a high-pressure nitrogen supply portion 240, a cleaning water supply portion 250 and a control portion 260 for controlling these components in harmony with each other.

The cleaning portion 220 comprises an electric motor 221 which is controlled by the control portion 260, a spin chuck 223 which is mounted on a rotation shaft 222 of this electric motor 221 to hold the semiconductor wafer W, and a two-fluid nozzle 230 disposed to oppose the spin chuck 223. The two-fluid nozzle 230 includes a gas passage 231 through which high-pressure nitrogen passes in the center, and a cleaning water passage 232 which is disposed around this gas passage 231 and through which cleaning water passes. Reference numeral 233 in FIG. 9 denotes a nozzle orifice. The gas passage 231 is connected to a nitrogen pipe 242 described later and the cleaning water passage 232 is connected to a cleaning water pipe 252 described later so as to introduce high-pressure nitrogen and cleaning water, respectively. The two-fluid nozzle 230 is supported by a lift/moving mechanism (not shown) so as to be able to change a supply position of the cleaning water within the plane of the semiconductor wafer W.

The high-pressure nitrogen supply portion 240 comprises a high-pressure nitrogen generating portion 241, a nitrogen pipe 242 for feeding high-pressure nitrogen from this high-pressure nitrogen generating portion 241 to the two-fluid nozzle 230, a pressure adjusting portion 243 provided halfway of this nitrogen pipe 242, a pressure sensor 244 for measuring the nitrogen pressure in this pressure adjusting portion 243, and a flow rate sensor 245 provided halfway of the nitrogen pipe 242. The pressure adjusting portion 243 adjusts the pressure according to an instruction from the control portion 260. Outputs of the pressure sensor 244 and the flow rate sensor 245 are inputted to the control portion 260.

The cleaning water supply portion 250 includes a cleaning water supply tank 251, a cleaning water pipe 252 for feeding the cleaning water from this cleaning water supply tank 251 to the two-fluid nozzle 230, a pressure adjusting portion 253 provided halfway of this cleaning water pipe 252, a pressure sensor 254 for measuring the pressure of the cleaning water in this pressure adjusting portion 253, and a flow rate sensor 255 provided halfway of the cleaning water pipe 252. The pressure adjusting portion 253 adjusts the pressure according to an instruction from the control portion 260. Outputs of the pressure sensor 254 and the flow rate sensor 255 are inputted to the control portion 260.

The cleaning water containing organic solvent includes alcohol (for example, ethyl alcohol, isopropyl alcohol and the like) or hydrofluoroether (for example, C₄F₉OCH₃, C₄F₉OC₂H₅ and the like).

The substrate cleaning apparatus 210 having such a structure cleans the semiconductor wafer W as follows. That is, the semiconductor wafer W is rotated by rotating the electric motor 221. The rotation speed at this time is, for example, about 500 rpm.

Next, the pressure adjusting portions 243, 253 are opened according to a signal from the control portion 260. When nitrogen and cleaning water are supplied to the two-fluid nozzle 230, the cleaning water is atomized by high-pressure nitrogen and sprayed to the surface of the semiconductor wafer W. As a consequence, particles are washed out. At this time, a control signal is sent from the control portion 260 to the respective pressure adjusting portions 243, 253 to adjust the pressures of nitrogen and cleaning water so that the cleaning water is sprayed at a predetermined pressure. At the same time, results detected by the respective pressure sensors 244, 254 and the flow rate sensors 245, 255 are fed back to the control portion 260 successively.

Here, an action of a case of using cleaning water containing organic solvent will be described in detail. That is, organic solvent has a surface tension smaller than that of pure water. Therefore, even when drying water left between device patterns, the adjoining patterns are never attracted by each other, so that they are protected from a damage.

As described above, the substrate cleaning method with the substrate cleaning apparatus 210 of this embodiment uses cleaning water containing organic solvent having a surface tension smaller than that of pure water. Therefore, when drying water left between the device patterns, the adjoining patterns are never attracted by each other, so that they are protected from a damage.

Here, an example of experiment will be described. A semiconductor wafer W in which 55 nm isolated pattern was formed was measured by a pattern inspecting device and the quantity of defects was counted. This semiconductor wafer was cleaned with the substrate cleaning apparatus 210 under the following condition 1 to condition 3.

The condition 1 is that C₄F₉OCH₃ is 0.2 MPa (100 ml/min), high-pressure nitrogen is 0.2 MPa (60 L/min) and the rotation number of the semiconductor wafer is 500 rpm. The condition 2 is that C₄F₉OC₂H₅ is 0.2 MPa (100 ml/min), high-pressure nitrogen is 0.2 MPa (60 L/min) and the rotation number of the semiconductor wafer is 500 rpm. The condition 3 is that pure water is 0.2 MPa (100 ml/min), high-pressure nitrogen is 0.2 MPa (60 L/min) and the rotation number of the semiconductor wafer is 500 rpm.

After the above-described treatment, the semiconductor wafer W was measured with the pattern inspecting device so as to count the quantity of defects. Further, the increased defects were observed with a review SEM so as to confirm whether or not the pattern was damaged. As a result, the rate of removal of defects was 60% for the condition 1, 70% for the condition 2 and 80% for the condition 3. Although no damage was found in the pattern under the condition 1 and condition 2, the pattern damages were found at seven positions under the condition 3. Therefore, the pressures of the cleaning water and high-pressure nitrogen are preferred to be 0.3 MPa or less.

FIGS. 10 and 11 are graphs showing the relation between the flow rate of nitrogen in the substrate cleaning apparatus 210 and the quantity of damages of the device pattern. Based on this relation, it is evident that the flow rate of nitrogen is preferred to be 70 L/min or less, that is, 0.0055 m² or less per 1 mm² in the nozzle orifice 233 of the two-fluid nozzle 230.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cleaning method comprising:
supplying alkaline cleaning water;
supplying high-pressure air; and
atomizing the supplied cleaning water by mixing with the air and spraying to a work piece.

2. The cleaning method according to claim 1, wherein the cleaning water includes ammonia.

3. The cleaning method according to claim 1, wherein the cleaning water includes organic alkali.

4. The cleaning method according to claim 1, wherein the cleaning water includes at least one of tetramethylammonium hydroxide, choline, and hydroxylamine.

5. The cleaning method according to claim 1, wherein the pressure of the cleaning water and the air is 0.1 MPa or more to 0.3 MPa or less.

6. A cleaning apparatus comprising:
cleaning water supply device which supplies alkaline cleaning water;
high-pressure air supply device which supplies high-pressure air; and
a two-fluid nozzle which atomizes the supplied cleaning water by mixing with the air and sprays to a work piece.

7. A cleaning apparatus comprising:
cleaning water supply device which supplies cleaning water;
high-pressure air supply device which supplies high-pressure air; and
a two-fluid nozzle which atomizes the supplied cleaning water by mixing with the air and sprays to a work piece,
wherein the two-fluid nozzle is formed of conductive material obtained by mixing nonconductive resin with carbon filler.

8. The cleaning apparatus according to claim 7, wherein the nonconductive resin includes any one of polyimide, polyether ether ketone, fluorine resin and mixture thereof.

9. The cleaning apparatus according to claim 7, wherein the two-fluid nozzle is grounded.

10. A cleaning apparatus comprising:
cleaning water supply device which supplies cleaning water;
high-pressure air supply device which supplies high-pressure air; and
a two-fluid nozzle which atomizes the supplied cleaning water by mixing with the air and sprays to a work piece,
wherein the two-fluid nozzle is formed of any of titanium, tantalum, zirconium and an alloy thereof.

11. The cleaning apparatus according to claim 10, wherein the two-fluid nozzle is grounded.

12. A cleaning apparatus comprising:
cleaning water supply device which supplies cleaning water;
high-pressure air supply device which supplies high-pressure air; and
a two-fluid nozzle which atomizes the supplied cleaning water by mixing with the air and sprays to a work piece,
wherein the two-fluid nozzle is formed of silicone, silicone carbide or a mixture thereof doped with impurity.

13. The cleaning apparatus according to claim 12, wherein the two-fluid nozzle is grounded.

14. An electronic device cleaning apparatus comprising:
cleaning water supply device which supplies cleaning water;
high-pressure air supply device which supplies high-pressure air; and
a nonconductive two-fluid nozzle which atomizes the supplied cleaning water by mixing with the air and sprays to a work piece,
wherein the two-fluid nozzle is provided with a grounding portion which grounds the cleaning water or the air passing through the two-fluid nozzle.

15. A cleaning apparatus comprising:
cleaning water supply device which supplies cleaning water;
high-pressure air supply device which supplies high-pressure air;
a two-fluid nozzle which atomizes the supplied cleaning water by mixing with the air and sprays to a work piece; and
an ionizer which neutralizes the electronic device.

16. A cleaning method comprising:
supplying cleaning water;
supplying high-pressure air;
atomizing the supplied cleaning water by mixing with the air and spraying to a work piece; and
neutralizing the work piece with an ionizer.

17. A cleaning method comprising:
supplying cleaning water containing organic solvent;
supplying high-pressure air; and
atomizing the supplied cleaning water by mixing with the air and spraying to a work piece.

18. The cleaning method according to claim 17, wherein the organic solvent contains at least any one of alcohol and hydrofluoroether.

19. The cleaning method according to claim 17, wherein the organic solvent contains at least any one of ethyl alcohol, isopropyl alcohol, C₄F₉OCH₃, C₄F₉OC₂H₅.

20. The cleaning method according to claim 17, wherein the pressure of the cleaning water and the air is 0.3 MPa or less.

21. The cleaning method according to claim 17, wherein a flow rate of the air is 0.0055 m² or less per 1 mm² in a nozzle orifice of the two-fluid nozzle.

22. A cleaning apparatus comprising:
cleaning water supply device which supplies cleaning water containing organic solvent;
high-pressure air supply device which supplies high-pressure air; and
a two-fluid nozzle which atomizes the supplied cleaning water by mixing with the air and sprays to a work piece.
